(19) United States
(12) Patent Application Publication
(10) Pub. No.: US 2026/0152050 A1
(43) Pub. Date: Jun. 4, 2026

(54) BODY OF VEHICLE

(71) Applicants: Hyundai Motor Company, Seoul (KR); Kia Corporation, Seoul (KR)

(72) Inventors: Seung Min Jeong, Hwaseong-si (KR); Joo Nam Kim, Hwaseong-si (KR)

(21) Appl. No.: 19/229,712

(22) Filed: Jun. 5, 2025

(30) Foreign Application Priority Data
Dec. 2, 2024 (KR) 10-2024-0176610

(51) Int. Cl. B60K 1/04; B60L 50/64; B62D 21/15; B62D 25/02; B62D 25/20; H01M 50/242; H01M 50/249; H01M 50/262

(52) U.S. Cl. CPC B60K 1/04; B60L 50/64; B62D 21/157; B62D 25/025; B62D 25/20; H01M 50/242; H01M 50/249; H01M 50/262; B60K 2001/0438; H01M 2220/20

(57) ABSTRACT

In an embodiment a body includes a side sill, a rigid member arranged within the side sill and extending in a longitudinal direction of the side sill, a support bracket arranged within the side sill, wherein the support bracket is connected at one end to the rigid member and at another end to the side sill, and a fastener configured to fasten a lower case of a battery pack to the side sill.

### CROSS-REFERENCE TO RELATED APPLICATIONS

This application claims priority from Korean Patent Application No. 10-2024-0176610 filed on Dec. 2, 2024 in the Korean Intellectual Property Office, the disclosure of which is incorporated herein by reference in its entirety.

### TECHNICAL FIELD

The present disclosure relates to a body of a vehicle including a fastener configured to fasten a lower case edge of a battery pack and a side sill to each other, a rigid member provided within the side sill to extend in a longitudinal direction of the vehicle, and a support bracket provided within the side sill and connected, at one end thereof, to the rigid member while being connected, at the other end thereof, to the side sill to support the rigid member.

### BACKGROUND

Technology for reducing carbon emissions is being actively developed in order to solve recent environmental problems such as abnormal temperature. For reduction of carbon emissions, energy should be produced through environmentally friendly methods without use of fossil fuels. The produced energy is stored in the form of electrical energy, and the stored electrical energy is used in vehicles, various industrial fields, and homes.

An increase in range of an electrified vehicle associated with a battery is a most important performance development target. To this end, a method capable of mounting a great number of batteries through maximal and efficient use of a limited space of the vehicle is being developed. In particular, a cell-to-vehicle (referred to as “CTV” hereinafter) structure in which a center floor of a vehicle body is integrated with an upper battery case is being highlighted.

Due to omission of the upper battery case, however, there are many difficulties in securing lateral collision safety and noise, vibration and harshness (NVH) performance.

The above matters disclosed in this section are merely for enhancement of understanding of the general background of the disclosure and should not be taken as an acknowledgement or any form of suggestion that the matters form the related art already known to a person skilled in the art.

### SUMMARY

An embodiment of the present disclosure provides a body of a vehicle including a fastener configured to fasten a lower case edge of a battery pack and a side sill to each other, a rigid member provided within the side sill to extend in a longitudinal direction of the vehicle, and a support bracket provided within the side sill and connected, at one end thereof, to the rigid member while being connected, at the other end thereof, to the side sill to support the rigid member.

Embodiments of the present disclosure are not limited to the above-described embodiment, and other embodiments of the present disclosure not yet described will be more clearly understood by those skilled in the art from the following detailed description.

In accordance with an embodiment of the present disclosure, the above and other embodiments can be accomplished by the provision of a body of a vehicle including a fastener configured to fasten a lower case edge of a battery pack and a side sill to each other, a rigid member provided within the side sill to extend in a longitudinal direction of the vehicle, and a support bracket provided within the side sill and connected, at one end thereof, to the rigid member while being connected, at another end thereof, to the side sill to support the rigid member.

The body may further include a floor coupled, at a lateral end thereof, to the side sill to constitute a bottom portion of an inner space of the vehicle and coupled to the lower case of the battery pack to cover the battery pack over the battery pack.

The floor may be shaped through a deep drawing process.

The floor may include an upper surface part configured to cover an upper portion of the battery pack, a side surface part extending downwards after being bent from a lateral end of the upper surface, and a flange part extending outwards after being bent from an end of the side surface part.

The side surface part may contact a side surface of the side sill, and the flange part may contact a lower surface of the side sill.

A first reinforcement member may be disposed at an inside of the floor to cover an area where the upper surface part and the side surface part of the floor are connected to each other.

The first reinforcement member may form a structure having a closed cross-section together with the upper surface part and the side surface part of the floor.

A second reinforcement member may be disposed at an outer portion of the floor and may be provided in an area between the upper surface part of the floor and the side surface of the side sill such that opposite ends thereof contact the upper surface part of the floor and the side surface of the side sill, respectively.

The second reinforcement member may form a structure having a closed cross-section together with the upper surface part of the floor and the side surface of the side sill.

An outermost member may be disposed along the edge of the lower case of the battery pack.

The fastener may be a mounting bolt fastened after extending through the lower case of the battery pack, the outermost member and the side sill.

A seal member may be disposed between the side sill and the outermost member.

The rigid member may be formed with a cavity therein, and a rigid member rib may be formed in the cavity to extend in the same direction as the rigid member.

An inner space of the side sill may include an upper space and a lower space, and the rigid member may be disposed at the upper space, and the support bracket may be disposed at the lower space.

A fixing bracket may be provided over the rigid member such that the fixing bracket is coupled to an upper surface of the rigid member and an inner surface of the side sill.

The support bracket may have a column shape and may be coupled to the side sill and the rigid member, thereby forming a closed cross-section.

A rim portion of the support bracket may surface-contact the side sill and the rigid member.

A reinforcement member may be provided within the support bracket while being formed with a surface contact portion configured to surface-contact the support bracket and an extension portion extending toward a side surface of the side sill after being bent from an end of the surface contact portion. A pipe nut may be provided within the support bracket such that the pipe nut is coupled, at one end thereof, to the extension portion of the reinforcement member while being coupled, at another end thereof, to the side sill.

The fastener may be inserted into the pipe nut while extending through a lower surface of the side sill.

Embodiments provide a vehicle including the body according to embodiments of the present disclosure.

### BRIEF DESCRIPTION OF THE DRAWINGS

The above and other objects, features and other advantages of embodiments of the present disclosure will be more clearly understood from the following detailed description taken in conjunction with the accompanying drawings, in which:

FIG. 1 is a view showing a vehicle body according to an embodiment;

FIG. 2 is a view showing an inner space of a side sill according to an embodiment;

FIG. 3 is an enlarged view showing a portion A of FIG. 2;

FIG. 4 is a view showing a cross-section of the vehicle body according to the embodiment;

FIG. 5 is a view showing a floor according to an embodiment; and

FIG. 6 is a view showing a battery pack according to an embodiment.

### DETAILED DESCRIPTION OF ILLUSTRATIVE EMBODIMENTS

In the following description of the embodiments of the present disclosure, a detailed description of known technologies incorporated herein will be omitted when it may obscure the subject matter of the embodiments of the present disclosure. In addition, the embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure. The following description is not intended to limit the present disclosure to the precise forms or particular fields of use disclosed. As such, it is contemplated that various alternate embodiments and/or modifications to the present disclosure, whether explicitly described or implied herein, are possible in light of the disclosure. A person of ordinary skill in the art will recognize that changes may be made in form and detail without departing from the scope of the present disclosure.

The present disclosure will be described with reference to specific embodiments. However, as one skilled in the art will appreciate, various embodiments disclosed herein can be modified or otherwise implemented in various other ways without departing from the spirit and scope of the disclosure. Accordingly, the following description is to be considered as illustrative and is for the purpose of teaching those skilled in the art the manner of making and using various embodiments. It is to be understood that the forms of disclosure herein shown and described are to be taken as representative embodiments. Equivalent elements, materials, processes or steps may be substituted for those representatively illustrated and described herein. Expressions such as “including”, “comprising”, “incorporating”, “consisting of”, “have”, and “is” used to describe the present disclosure are intended to be construed in a non-exclusive manner, namely, in a manner allowing items, components or elements not explicitly described to also be present. Unless clearly used otherwise, singular expressions should be interpreted as including a plural meaning.

Furthermore, various embodiments disclosed herein are to be taken in the illustrative and explanatory sense, and should in no way be construed as limiting of the present disclosure. All references as to joining (e.g., attached, affixed, coupled, connected, and the like) are only used to aid understanding of the present disclosure, and may not create limitations, particularly as to the position, orientation, or use of the configuration or the method disclosed herein. Therefore, references as to joining, if any, are to be construed broadly. Moreover, such references as to joining do not necessarily infer that two elements are directly connected to each other. Additionally, all numerical terms, such as, but not limited to, “first”, “second”, “third”, “primary”, “secondary”, “main” or any other ordinal or numerical terms, should also be taken only as identifiers, to assist understanding of various elements, embodiments, variations or modifications of the present disclosure, and may not mean any limitation as to embodiment, variation or modification of any element or any limitation as to the order or preference thereof. That is, although such expressions may be used to describe various constituent elements, these constituent elements are not limited by the expressions associated therewith. Such expressions are used only to distinguish one constituent element from another constituent element.

The suffixes “module” and “unit” of elements herein are used for convenience of description and thus can be used interchangeably and do not have any distinguishable meanings or functions.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, embodiments including various characterized parts having various arrangements will be described with reference to the accompanying drawings.

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

As mentioned above, a cell-to-vehicle (referred to as “CTV” hereinafter) structure in which a center floor of a vehicle body is integrated with an upper battery case is being highlighted. Due to omission of the upper battery case, however, there are many difficulties in securing lateral collision stability and noise, vibration and harshness (NVH) performance.

Therefore, the embodiments of the present disclosure are intended to provide a body of a vehicle configured to secure safety and driving performance of the vehicle through an enhancement in lateral collision safety and NVH performance while achieving a reduction in weight and an increase in battery cell mounting space.

Meanwhile, although a CTV structure in which a floor part functions as an upper case of a battery pack is illustrated as an example of the vehicle body, this is only for convenience of description, and the scope of the present disclosure should be not interpreted as being limited to the CTV structure. It should be interpreted that various vehicle bodies configured to enable a battery to be mounted to a vehicle fall within the scope of the present disclosure.

In addition, embodiments of the present disclosure are applicable to a variety of vehicles such as electrified vehicles, fuel cell vehicles, hybrid vehicles, etc. to which a battery is coupled. That is, it will be appreciated that various structures and systems capable of storing and supplying electrical energy in a vehicle fall within the scope of the present disclosure, irrespective of the kind of the vehicle.

Furthermore, embodiments of the present disclosure are applicable to various fields associated with an energy storage system (ESS) for industrial purposes, an ESS for domestic purposes, a small-size battery pack, etc.

A body of a vehicle according to embodiments of the present disclosure may include a fastener 100 configured to fasten an edge of a lower case 510 of a battery pack 500 and a side sill 10 to each other, a rigid member 200 provided within the side sill 10 to extend in a longitudinal direction of the vehicle, and a support bracket 300 provided within the side sill 10 and connected, at one end thereof, to the rigid member 200 while being connected, at the other end thereof, to the side sill 10 to support the rigid member 200.

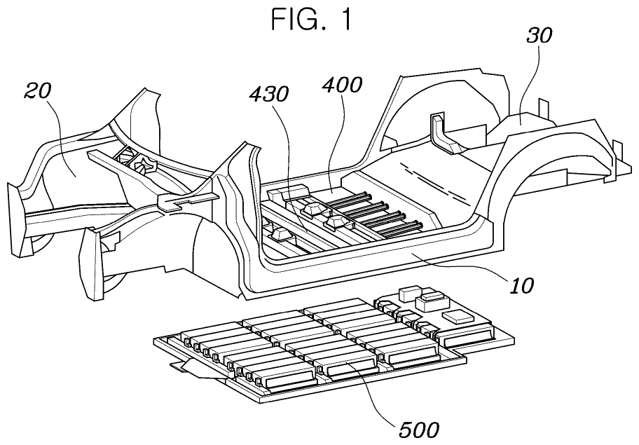

Referring to FIG. 1, the side sill 10 may be provided in a pair such that the pair of side sills 10 is disposed at opposite lateral ends of the vehicle body, respectively, to extend in a longitudinal direction of the vehicle while being spaced apart from each other in a width direction of the vehicle. A front side member 20 may be coupled to a front portion of the side sill 10 and a rear side member 30 may be coupled to a rear portion of the side sill 10 to form a main frame of the vehicle body. A battery pack 500 may be coupled to the vehicle body under the vehicle body such that the battery pack 500 is disposed between the pair of side sills 10.

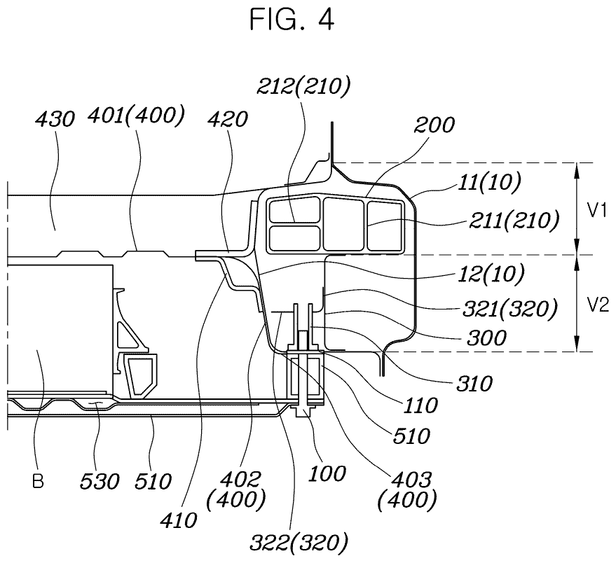

Referring to FIG. 4, the side sill 10 may include an outer part 11 disposed at an outer surface of the vehicle body and an inner part 12 disposed at an inner surface of the vehicle body. In accordance with coupling between the outer part 11 and the inner part 12, an inner space of the side sill 10 may be formed. The inner space of the side sill 10 may be divided into an upper space V1, in which the rigid member 200 is disposed, and a lower space V2, in which the support bracket 300 is disposed. In addition, the inner part 12 may be bent at a boundary between the upper space V1 and the lower space V2.

In an embodiment, the rigid member 200 is provided within the inner space of each of the pair of side sills 10 to protect the battery pack 500 disposed between the pair of side sills 10. In addition, a load path against external impact may be formed through the support bracket 300 configured to support the rigid member 200. Accordingly, when external impact is generated, the rigid member 200 may be rotated and, as such, may be prevented from penetrating into the battery pack 500.

In an embodiment, a floor 400 may be coupled, at a lateral end thereof, to the side sill 10 to constitute a bottom portion of an inner space of the vehicle, and may be coupled to the lower case 510 of the battery pack 500 to cover the battery pack 500 over the battery pack 500.

In an embodiment, the floor 400 may be made of a material having relatively high stiffness because the floor 400 should constitute the bottom portion of the inner space of the vehicle and should cover and protect an upper portion of the battery pack 500. In particular, when fire breaks out in the battery pack 500, propagation of the fire to the inner space of the vehicle should be prevented and, as such, the floor 400 may be formed of a metal material. For example, when formability and lightness are important, the floor 400 may be formed of aluminum. On the other hand, when stability and protection performance are important, the floor 400 may be formed of stainless steel. Of course, these are illustrative, and the material of the floor 400 is not limited to the above-described examples.

In an embodiment, the floor 400 has a centrally-protruding panel shape and, as such, may effectively cover an upper portion of the battery pack 500 in a state of being coupled to the lower case 510 of the battery pack 500. For shaping of the floor 400 as described above, various processes may be used. For example, the floor 400 may be shaped through a deep drawing process. In this case, the floor 400 may be formed to have a uniform thickness at the entirety thereof while reducing a formation time and formation costs thereof.

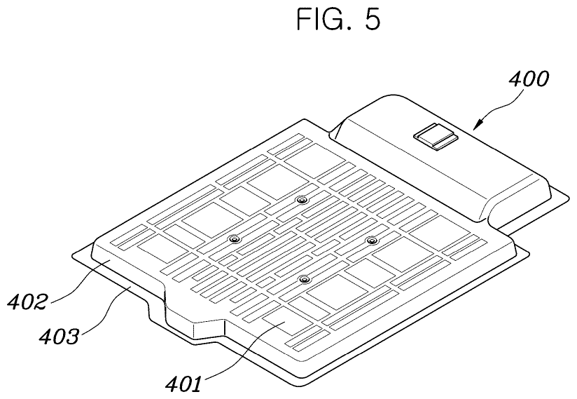

Referring to FIG. 5, the floor 400 may include an upper surface part 401 configured to cover the upper portion of the battery pack 500, a side surface part 402 extending downwards after being bent from a lateral end of the upper surface part 401, and a flange part 403 extending outwards after being bent from an end of the side surface part 402.

Referring to FIG. 4, the side surface part 402 of the floor 400 contacts a side surface of the side sill 10, and the flange part 403 contacts a lower surface of the side sill 10. Accordingly, a load path extending from the side sill 10 to the upper surface part 401 of the floor 400 via the side surface part 402 of the floor 400 is formed and, as such, impact performance against external impact may be secured.

In an embodiment, a cross member 430 may be disposed at the upper surface part 401 of the floor 400 to cross the floor 400.

Referring to FIG. 4, the cross member 430 is coupled, at opposite ends thereof, to respective side sills 10 while extending in the width direction of the vehicle and, as such, may more effectively support the side sills 10. In addition, the cross member 430 may form the load path extending from the side sills 10 to the floor 400 and, as such, may secure impact performance against external impact.

In an embodiment, a first reinforcement member 410 may be disposed at an inside of the floor 400. The first reinforcement member 410 may be provided in an area where the upper surface part 401 and the side surface part 402 of the floor 400 are connected to each other.

Referring to FIG. 4, the first reinforcement member 410 may form a structure having a closed cross-section together with the upper surface part 401 and the side surface part 402 of the floor 400 as the first reinforcement member 410 is disposed in the area where the upper surface part 401 and the side surface part 402 of the floor 400 are connected to each other. For example, the first reinforcement member 410 may protrude toward the battery pack 500 and may surface-contact the upper surface part 401 and the side surface part 402 of the floor 400 at opposite ends thereof, respectively, and, as such, may form a closed cross-section. Through such a structure, the first reinforcement member 410 may reinforce an area between the upper surface part 401 and the side surface part 402 of the floor 400 and may form a load path against external impact, and, as such, may secure impact performance.

In an embodiment, a second reinforcement member 420 may be disposed at an outer portion of the floor 400. The second reinforcement member 420 may be provided in an area between the upper surface part 401 of the floor 400 and the side surface of the side sill 10 such that opposite ends thereof contact the upper surface part 401 and the side surface of the side sill 10, respectively.

Referring to FIG. 4, the second reinforcement member 420 may form a structure having a closed cross-section together with the upper surface part 401 of the floor 400 and the side surface of the side sill 10. For example, the second reinforcement member 420 surface-contacts the upper surface part 401 of the floor 400 at one end thereof while surface-contacting the side surface of the side sill 10 at the other end thereof, thereby forming a closed cross-section. Through such a structure, the second reinforcement member 420 may support the floor 400 and the side sill 10 and may form a load path against external impact, and, as such, may secure impact performance.

In an embodiment, the first reinforcement member 410 may be disposed at a lateral side of the lower space V2 of the side sill 10, and the second reinforcement member 420 may be disposed at a lateral side of the upper space V1 of the side sill 10. When only one of the first reinforcement member 410 and the second reinforcement member 420 is disposed, it may be possible to more effectively support the side sill 10 and the floor 400 and to form a load path against external impact, and, as such, to secure impact performance.

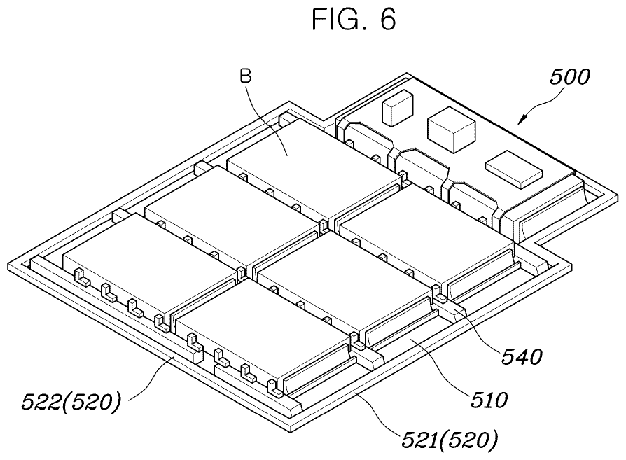

Referring to FIG. 6, in an embodiment, an outermost member 520 may be disposed along the edge of the lower case 510 of the battery pack 500, and an installation space surrounded by the outermost member 520 may be formed over the lower case 510 of the battery pack 500. The upper portion of the battery pack 500 may be opened, and the floor 400 may be coupled to the lower case 510 of the battery pack 500 to cover the battery pack 500 over the battery pack 500.

A plurality of battery cells may be installed in an intermediate form of a module or a cell module assembly (CMA) in the installation space of the battery pack 500. In the case of FIG. 5, a plurality of battery cells constitutes one battery module B in accordance with assembly thereof, and a plurality of battery modules B may be mounted in the installation space of the battery pack 500. In addition, a cross member 540 crossing the lower case 510 of the battery pack 500 may be disposed among the plurality of battery modules B mounted in the installation space to form a load path against external impact and, as such, impact performance may be secured.

In an embodiment, the outermost member 520 may include a longitudinal member 521 extending in the longitudinal direction of the vehicle, and a transverse member extending in the width direction of the vehicle.

Referring to FIG. 4, the outermost member 520 may have a closed cross-sectional shape formed with a cavity therein. For shaping of the outermost member 520 as described above, various processes may be used. For example, the outermost member 520 may be formed through an extrusion process to have a closed cross-sectional shape having a cavity therein. Extrusion directions of the longitudinal member 521 and the transverse member 522 constituting the outermost member 520 may perpendicularly cross each other.

In an embodiment, the lower case 510 of the battery pack 500 may be coupled to a lower surface of the side sill 10, and the outermost member 520 may be disposed between the lower case 510 of the battery pack 500 and the lower surface of the side sill 10.

In an embodiment, the fastener 100 may be a mounting bolt extending through the lower case 510 of the battery pack 500, the outermost member 520 and the lower surface of the side sill 10, and may be inserted into and fastened to a pipe nut 310, as will be described later. In addition, a seal member 110 may be disposed between the side sill 10 and the outermost member 520 to seal the battery pack 500. For example, the seal member 100 may include a gasket.

In an embodiment, a cooling channel 530, through which a cooling medium flows, may be formed at the lower case 510 of the battery pack 500.

In an embodiment, the rigid member 200 may be provided within the side sill 10 to extend in the longitudinal direction of the vehicle.

Referring to FIG. 4, the rigid member 200 may be formed with a cavity therein, and a rigid member rib 210 may be formed in the cavity of the rigid member 200 to extend in the same direction as the rigid member 200. Accordingly, both lightness and stiffness reinforcement may be secured.

In an embodiment, the rigid member rib 210 may include a vertical rib 211 configured to support upper and lower surfaces of the rigid member 200, and a horizontal rib 212 configured to support a side surface of the rigid member 200 and the vertical rib 211.

In an embodiment, the rigid member 200 may be disposed at the upper space V1 of the side sill 10, and the support bracket 300 may be disposed at the lower space V2 of the side sill 10. A fixing bracket 220 may be provided over the rigid member 200 such that the fixing bracket 220 is coupled to the upper surface of the rigid member 200 and an inner surface of the side sill 10.

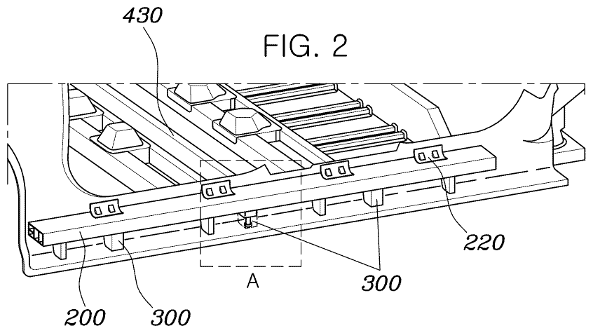

Referring to FIG. 2, the fixing bracket 220 may be disposed in an area between the upper surface of the rigid member 200 and the inner surface of the side sill 10, and may be centrally bent such that opposite ends thereof surface-contact the upper surface of the rigid member 200 and the inner surface of the side sill 10, respectively. In addition, the fixing bracket 220 may be provided in plural such that the plurality of fixing brackets 220 is spaced apart from one another in the longitudinal direction of the vehicle. The fixing bracket 220 fixes the rigid member 200 to the side sill 10 and, as such, rotation of the rigid member 200 may be prevented when external impact is generated.

In an embodiment, the support bracket 300 may be provided within the side sill 10, and may be connected, at one end thereof, to the rigid member 200 while being connected, at the other end thereof, to the side sill 10, thereby supporting the rigid member 200.

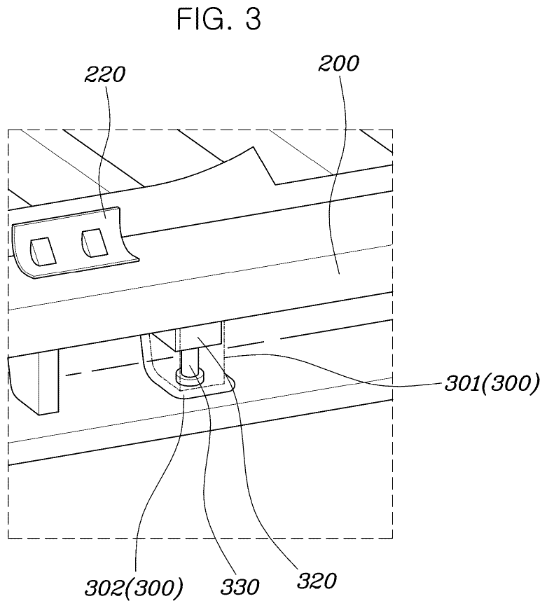

Referring to FIG. 2 and FIG. 3, the support bracket 300 may be disposed under the rigid member 200 to support the rigid member 200, and may be provided in plural such that the plurality of support brackets 300 is spaced apart from one another in the longitudinal direction of the vehicle.

Referring to FIG. 4, the support bracket 300 may be disposed at the lower space V2 of the side sill 10, and may be coupled to the side sill 10 and the rigid member 200 to form a column shape and, as such, to form a closed cross-section.

In an embodiment, the support bracket 300 may be formed with a column portion 301 extending in a height direction to effectively support the rigid member 200. In addition, the support bracket 300 may be formed with a rim portion 302 extending to contact the side sill 10 or the rigid member 200 after being bent at an end of the column portion 301. The rim portion 302 may surface-contact the inner surface of the side sill 10 and the lower surface of the rigid member 200.

In an embodiment, a reinforcement member 320 may be provided within the support bracket 300. The reinforcement member 320 may be formed with a surface contact portion 321 configured to surface-contact the support bracket 300, and an extension portion 322 extending toward a side surface of the side sill 10 after being bent from an end of the surface contact portion 321. In addition, the pipe nut 310, which is coupled, at one end thereof, to the extension portion 322 of the reinforcement member 320 while being coupled, at the other end thereof, to the side sill 10, may be provided within the support bracket 300.

In an embodiment, the surface contact portion 321 of the reinforcement member 320 may extend in a height direction to surface-contact an inner surface of the column portion 301 of the support bracket 300, and the extension portion 322 may extend toward the side surface of the side sill 10 after being bent from the end of the surface contact portion 321. Accordingly, it may be possible to prevent deformation of the support bracket 300 when external impact is generated.

In an embodiment, the pipe nut 310 may be coupled, at one end thereof, to the extension portion 322 of the reinforcement member 320 while being coupled, at the other end thereof, to the lower surface of the side sill 10. In addition, the pipe nut 310 has a pipe shape extending in a height direction and, as such, may assist in support of the rigid member 200 by the support bracket 300.

In addition, the fastener 100 may be connected to the pipe nut 310. For example, the fastener 100 may be a mounting bolt. In this case, the fastener 100 is inserted into and fastened to the pipe nut 310 after extending through a lower portion of the side sill 10. Accordingly, it may be possible to more firmly fasten the floor 400 and the battery pack 500 to the side sill 10, as compared to the case in which the fastener 100 is simply coupled to the lower surface of the side sill 10.

As apparent from the above description, in accordance with the vehicle body of embodiments of the present disclosure, it may be possible to secure safety and driving performance of the vehicle, to which the vehicle body is applied, through an enhancement in lateral collision safety and NVH performance while achieving a reduction in weight and an increase in battery cell mounting space.

Effects attainable in the present disclosure are not limited to the above-described effects, and other effects of the present disclosure not yet described will be more clearly understood by those skilled in the art from the above-described detailed description.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A body comprising:
a side sill;
a rigid member arranged within the side sill and extending in a longitudinal direction of the side sill;
a support bracket arranged within the side sill,
wherein the support bracket is connected at one end to the rigid member and at another end to the side sill; and
a fastener configured to fasten a lower case of a battery pack to the side sill.

2. The body of claim 1, further comprising:
a floor constituting a bottom portion of an inner space of a vehicle,
wherein a lateral end of the floor is coupled to the side sill, and
wherein the lateral end of the floor is coupled to the lower case of the battery pack.

3. The body of claim 2, wherein the floor is shaped through a deep drawing process.

4. The body of claim 2, wherein the floor comprises an upper surface configured to cover an upper portion of the battery pack, a side surface extending downwards from a lateral end of the upper surface, and a flange extending outwards from an end of the side surface.

5. The body of claim 4, wherein the side surface directly contacts a side surface of the side sill, and the flange directly contacts a lower surface of the side sill.

6. The body of claim 4, further comprising a first reinforcement located inside the floor and covering an area where the upper surface and the side surface of the floor are connected to each other.

7. The body of claim 6, wherein the first reinforcement forms a structure having a closed cross-section together with the upper surface and the side surface of the floor.

8. The body of claim 6, further comprising a second reinforcement located at an outer portion of the floor and provided in an area between the upper surface of the floor and the side surface of the side sill, wherein opposite ends of the second reinforcement contact the upper surface of the floor and the side surface of the side sill, respectively.

9. The body of claim 8, wherein the second reinforcement forms a structure having a closed cross-section together with the upper surface of the floor and the side surface of the side sill.

10. The body of claim 1, further comprising a seal, wherein the battery pack comprises an outermost member arranged along an edge of the lower case of the battery pack, and wherein the fastener is a mounting bolt fastening an outmost member and the seal to the side sill.

11. The body of claim 1, wherein the rigid member comprises a cavity and a rigid member rib, wherein rigid member rib extends in the same direction as the rigid member.

12. The body of claim 1,
wherein the side sill comprises an inner space,
wherein the inner space is divided into an upper space and a lower space, and
wherein the rigid member is located in the upper space and the support bracket is located in the lower space.

13. The body of claim 12, further comprising a fixing bracket, wherein the fixing bracket couples an upper surface of the rigid member to an inner surface of the side sill.

14. The body of claim 1, wherein the support bracket has a column shape and is coupled to the side sill and the rigid member forming a closed cross-section.

15. The body of claim 14, wherein a rim portion of the support bracket surface-contacts the side sill and the rigid member.

16. The body of claim 14, wherein the support bracket comprises a reinforcement including a surface contact portion configured to surface-contact the support bracket and an extension portion extending toward a side surface of the side sill after a bent at an end of the surface contact portion, and a pipe nut coupled, at one end to the extension portion of the reinforcement and at another end to the side sill.

17. The body of claim 16, wherein the fastener is inserted into the pipe nut and extends through a lower surface of the side sill.

18. A vehicle body comprising:
a side sill comprising a rigid member arranged within and extending in a longitudinal direction of the side sill, and a support bracket arranged within the side sill,
a floor of an inner space of a vehicle;
a battery pack,
wherein the floor is connected to the side sill, and
wherein the support bracket is connected at one end to the rigid member and at another end to the side sill; and
a fastener fastening the battery pack to the side sill.

19. The vehicle body of claim 18, further comprising:
a fixing bracket,
wherein the side sill comprises an inner space,
wherein the inner space is divided into an upper space and a lower space,
wherein the rigid member is located in the upper space and the support bracket is located in the lower space, and
wherein the fixing bracket couples an upper surface of the rigid member to an inner surface of the side sill.

20. A vehicle comprising:
a first side sill comprising a first rigid member arranged within and extending in a longitudinal direction of the first side sill, and a plurality of first support brackets arranged within the first side sill,
a second side sill comprising a second rigid member arranged within and extending in a longitudinal direction of the second side sill, and a plurality of second support brackets arranged within the second side sill,
a floor of an inner space of the vehicle, the floor connecting the first side sill to the second side sill,
wherein the first support brackets are connected at one end to the first rigid member and at another end to the first side sill, and
wherein the second support brackets are connected at one end to the second rigid member and at another end to the second side sill;
a battery pack; and
fasteners fastening the battery pack to the first and second side sills.
